(19) United States
(12) Patent Application Publication
(10) Pub. No.: US 2024/0123734 A1
(43) Pub. Date: Apr. 18, 2024

(54) LIQUID CONTAINER AND PRINTING APPARATUS

(71) Applicant: CANON KABUSHIKI KAISHA, Tokyo (JP)

(72) Inventor: HIROSHI YAMADA, Kanagawa (JP)

(21) Appl. No.: 18/473,052

(22) Filed: Sep. 22, 2023

(30) Foreign Application Priority Data
Oct. 12, 2022 (JP) 2022-164270

(51) Int. Cl. B41J 2/175

(52) U.S. Cl. CPC B41J 2/17509; B41J 2/17513; B41J 2/17523; B41J 2/17553

(57) ABSTRACT

There is provided a liquid container having increased usability over conventional art. The liquid container includes a main body including a storage chamber storing liquid and a nozzle projecting from the main body. In the nozzle, first, second, and third flow paths are formed. The first flow path brings the storage chamber into communication with the outside through a first opening formed on an edge face constituting a leading edge of the nozzle. The second and third flow paths bring the storage chamber into communication with the outside through a second opening and a third opening formed on the edge face, respectively. In a case where the edge face is viewed from the perpendicular direction of the edge face, the centroid of the third opening is not located on a line connecting the centers of gravity of the first and second openings.

### BACKGROUND

### Field of the Disclosure

The present disclosure relates to a liquid container and a printing apparatus.

In general, there are liquid containers each of which is capable of injecting liquid while performing a gas-liquid exchange by being connected to a liquid tank.

Japanese Patent Laid-Open No. 2020-189454 discloses a liquid container in which two openings formed at a leading edge of a nozzle are aligned in an up-and-down direction and from which liquid can be injected while making a gas-liquid exchange by connecting the liquid container to a liquid tank with a mark of the liquid container oriented upward.

However, a user must connect the liquid container disclosed in Japanese Patent Laid-Open No. 2020-189454 to the liquid tank while being conscious of the above-described mark. Further, for some reason, in a case where the liquid container is connected to the liquid tank with the two openings aligned in a nearly horizontal direction, there is a possibility that a gas-liquid exchange at the time of liquid injection, that is, a liquid supply may not be carried out smoothly. This is because a difference in height (that is, a difference in water head pressure) between the two openings is less likely to be made.

The object of the present disclosure is then to provide a liquid container having increased usability over conventional art.

### SUMMARY

In a first aspect of the present invention, there is provided a liquid container comprising a main body including a storage chamber storing liquid; and a nozzle projecting from the main body, wherein in the nozzle, a first flow path, a second flow path, and a third flow path are formed, the first flow path brings the storage chamber into communication with an outside through a first opening formed on an edge face constituting a leading edge of the nozzle, the second flow path brings the storage chamber into communication with the outside through a second opening formed on the edge face, the third flow path brings the storage chamber into communication with the outside through a third opening formed on the edge face, and in a case where the edge face is viewed from a perpendicular direction of the edge face, a centroid of the third opening is not located on a line connecting a centroid of the first opening and a centroid of the second opening.

In a second aspect of the present invention, there is provided a printing apparatus comprising a print head configured to eject liquid to perform printing; a liquid tank connectable to a liquid container; and a tube capable of supplying liquid from the liquid tank to the print head, wherein the liquid container comprises the liquid tank connectable via a nozzle to a liquid container comprising a main body including a storage chamber storing liquid and the nozzle projecting from the main body, wherein in the nozzle, a first flow path, a second flow path, and a third flow path are formed, the first flow path brings the storage chamber into communication with an outside through a first opening formed on an edge face constituting a leading edge of the nozzle, the second flow path brings the storage chamber into communication with the outside through a second opening formed on the edge face, the third flow path brings the storage chamber into communication with the outside through a third opening formed on the edge face, and in a case where the edge face is viewed from a perpendicular direction of the edge face, a centroid of the third opening is not located on a line connecting a centroid of the first opening and a centroid of the second opening, the liquid tank being capable of storing liquid injected from the liquid container.

Further features of the present invention will become apparent from the following description of exemplary embodiments with reference to the attached drawings.

### BRIEF DESCRIPTION OF THE DRAWINGS

FIG. 1 is a schematic perspective view of the outer appearance of a printing apparatus according to one embodiment;

FIG. 2 is a schematic perspective view of a liquid tank set according to one embodiment;

FIG. 3 is a cross-sectional view taken along line III-III in FIG. 2;

FIG. 4 is a schematic perspective view of a liquid container according to one embodiment;

FIG. 5 is a schematic diagram of a bottle main body according to one embodiment;

FIG. 6 is a schematic perspective view of a bottle cap according to one embodiment;

FIG. 7 is a cross-sectional view taken along line VII-VII in FIG. 6;

FIG. 8 is an enlarged view of a region VIII shown in FIG. 3;

FIG. 9 is a schematic plan view of an edge face according to one embodiment;

FIG. 10A is a diagram showing an example of connection postures in which two openings are located downward in the direction of gravity;

FIG. 10B is a diagram showing an example of connection postures different from that in FIG. 10A;

FIG. 11A is a schematic plan view of the edge face of a nozzle according to one embodiment;

FIG. 11B is a diagram showing the edge face in a state where a bottle according to one embodiment is rotated about 60 degrees clockwise from the state shown in FIG. 11A;

FIG. 12 is a schematic perspective view of the bottle cap according to one embodiment;

FIG. 13A is a schematic plan view of the edge face according to one embodiment; and

FIG. 13B is a diagram showing a state where the bottle according to one embodiment is rotated about 45 degrees clockwise from the state shown in FIG. 13A.

### DESCRIPTION OF THE EMBODIMENTS

### First Embodiment

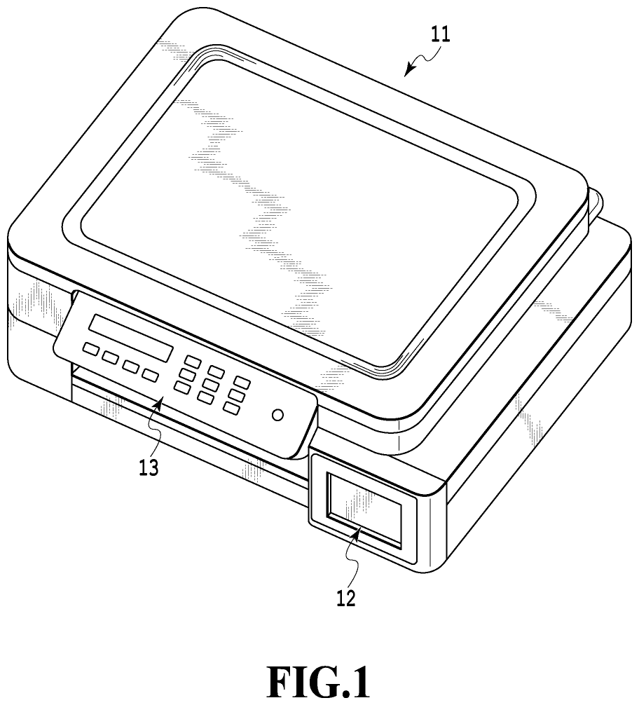

FIG. 1 is a schematic perspective view of the outer appearance of a printing apparatus 11 according to the present embodiment.

An up-and-down direction in the present specification is defined relative to the posture of the printing apparatus 11 usably installed on a horizontal face. A back-and-forth direction in the present specification is defined on the assumption that a face on which an operation panel 13 of the printing apparatus 11 is provided is a front face. A left-and-right direction in the present specification is defined by viewing the printing apparatus 11 from the front.

### Printing Apparatus 11

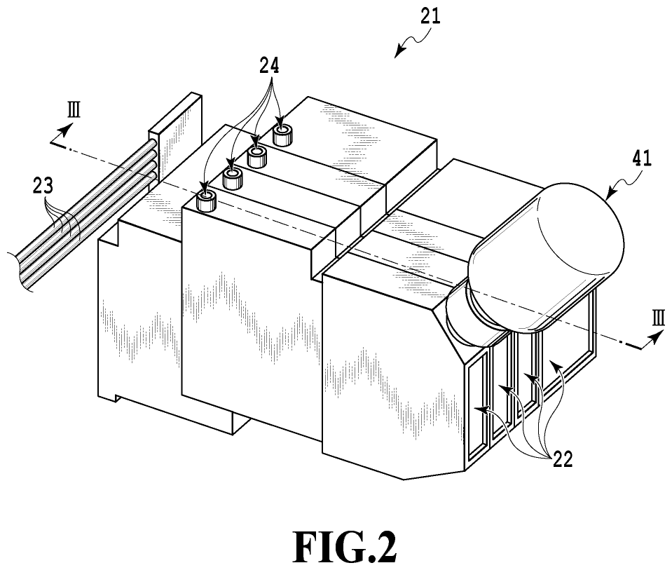

As shown in FIG. 1, an opening/closing lid 12 is attached to a main body of the printing apparatus 11. Behind the opening/closing lid 12, there is accommodation space in which a liquid tank set 21 (see FIG. 2) is accommodated. The opening/closing lid 12 is rotatable between a closed position (the position shown in FIG. 1) where the accommodation space is blocked and an open position where the accommodation space is opened. In a case where the opening/closing lid 12 is in the open position, a portion of the liquid tank set 21 (see FIG. 2) is visible from the outside. In the present embodiment, ink is used as an example of liquid to give a description, but liquid usable in the present embodiment is not limited to ink.

Further, the front face of the printing apparatus 11 is provided with the operation panel 13 for a user to input various commands and check information on the printing apparatus 11. In addition, the printing apparatus 11 also includes a printing unit (not shown) that prints an image on a print medium such as paper by an inkjet printing method. The printing unit includes a carriage movable in the left-and-right direction as viewed from the front, and a print head. Liquid droplets are ejected from the print head, so that an image is printed on a print medium.

### [Liquid Tank Set 21]

FIG. 2 is a schematic perspective view of the liquid tank set 21 according to the present embodiment. In the present example, a bottle 41, which is an example of liquid containers, is detachably connected to a liquid tank 22 included in the liquid tank set 21. Hereinafter, the posture of the bottle 41 at the time of being connected to the liquid tank 22 will be referred to as a “connection posture.”

As shown in FIG. 2, the liquid tank set 21 includes four liquid tanks 22 respectively storing different types of liquids (e.g., inks of different colors) to be supplied to the print head. It should be noted that the number of liquid tanks 22 is not limited to four. A tube 23 extends from each liquid tank 22. The tube 23 connects the liquid tank set 21 to the print head. The tube 23 supplies the print head with liquid stored in each liquid tank 22 of the liquid tank set 21. The four tubes 23 through which liquids of respective colors circulate are connected to respective liquid tanks 22 correspondingly. The liquid tank 22 is formed so as to include resin having translucency to the extent that liquid inside the liquid tank 22 is visible from the outside. An air communication port 24 for bringing the inside into communication with air is formed in the liquid tank 22.

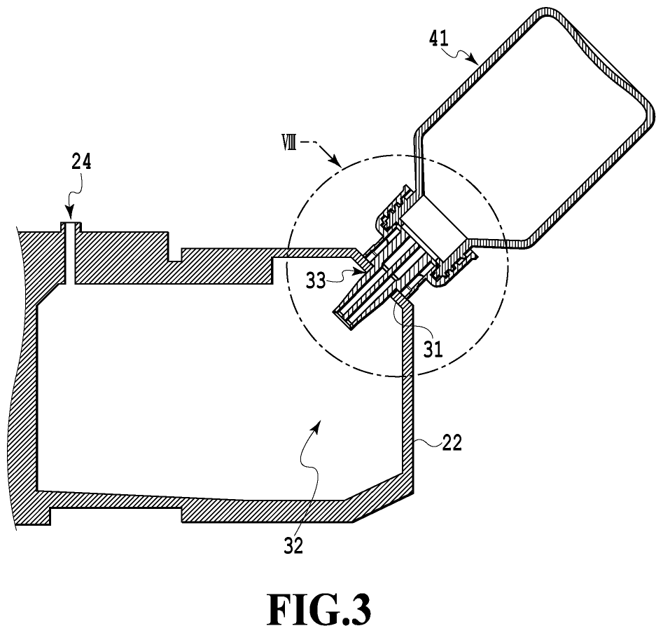

FIG. 3 is a cross-sectional view taken along line III-III in FIG. 2.

As shown in FIG. 3, the liquid tank 22 includes a tank storage chamber 32 that stores liquid. The air communication port 24 is used to bring the inside of the tank storage chamber 32 into communication with air. The front face of the liquid tank 22 is provided with an inclined wall 31 to which the bottle 41 can be connected by being inclined. The inclined wall 31 is inclined rearward from the upper end of the front face of the liquid tank 22 with respect to a planar direction (the left-and-right direction in the figure) and a perpendicular direction (the up-and-down direction in the figure). An insertion slot portion 33 for injecting liquid into the tank storage chamber 32 is formed on the inclined wall 31.

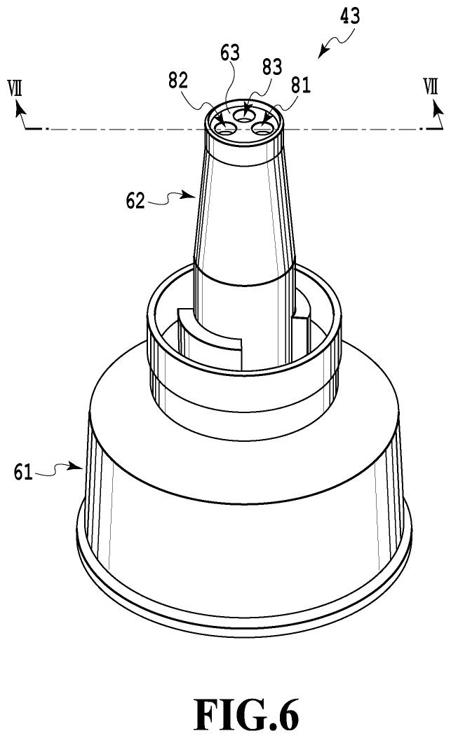

In a case where the opening/closing lid 12 (see FIG. 1) is in the open position, the tank storage chamber 32 is communicated with the outside of the liquid tank 22 via the insertion slot portion 33. The bottle 41 is connected to the liquid tank 22 by a nozzle 62 (see FIG. 6) of the bottle 41 being inserted into the insertion slot portion 33. The bottle 41 is connected to the liquid tank 22, so that liquid in the bottle 41 can flow into the tank storage chamber 32 of the liquid tank 22.

### [Liquid Container]

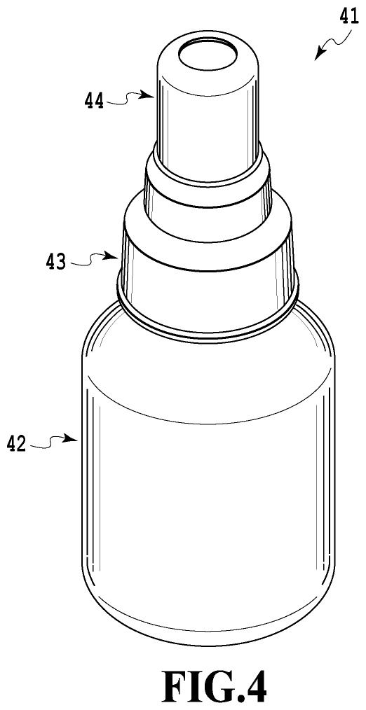

FIG. 4 is a schematic perspective view of the liquid container (bottle 41) according to the present embodiment.

As shown in FIG. 4, the bottle 41 includes a substantially cylindrical bottle main body 42 that stores liquid such as ink therein, a bottle cap 43 attachable to and detachable from the bottle main body 42, and a nozzle cap 44 attachable to and detachable from the bottle cap 43.

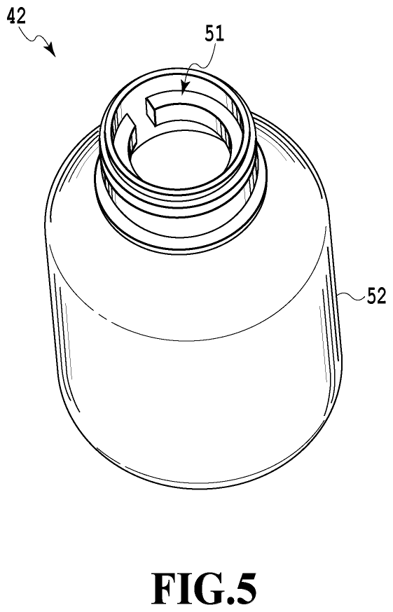

FIG. 5 is a schematic diagram of the bottle main body 42 according to the present embodiment.

As shown in FIG. 5, a bottle opening 51 is formed at an end of the bottle main body 42. A bottle storage chamber 52 that stores liquid in the bottle main body 42 is communicated with the outside of the bottle main body 42 through the bottle opening 51. A male thread is formed on an outer peripheral wall near the bottle opening 51.

FIG. 6 is a schematic perspective view of the bottle cap 43 according to the present embodiment.

The bottle cap 43 shown in FIG. 6 is a component attachable to and detachable from the bottle main body 42. As shown in FIG. 6, the bottle cap 43 includes a cap main body 61 and a nozzle 62 projecting from the cap main body 61. A female thread is formed on the inner peripheral face of the side wall of the cap main body 61. The female thread can be screwed to the male thread of the bottle main body 42. The bottle cap 43 is attached to the bottle main body 42 by the male thread and the female thread being screwed to each other. Incidentally, the bottle cap 43 may be formed integrally with the bottle main body 42.

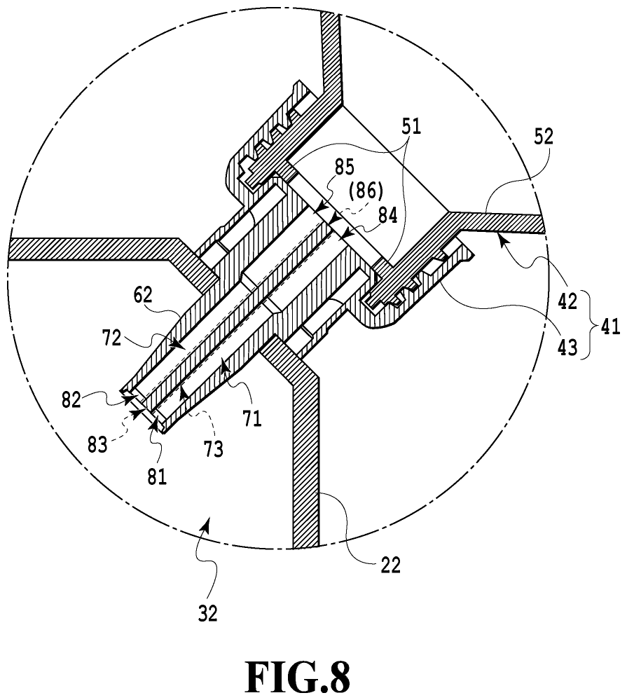

In the present embodiment, three openings (a first opening 81, a second opening 82, and a third opening 83) are formed on an edge face 63 constituting the leading edge of the nozzle 62 in a projecting direction in which the nozzle 62 is projected. That is, the three openings are formed on the same plane. Incidentally, the first opening 81, the second opening 82, and the third opening 83 will be described later with reference to FIG. 8.

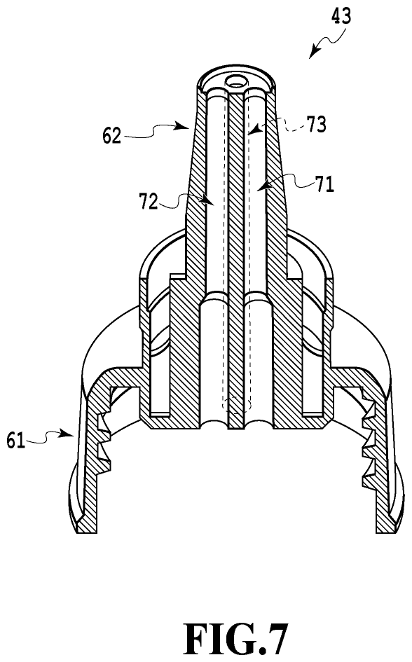

FIG. 7 is a cross-sectional view taken along line VII-VII in FIG. 6.

As shown in FIG. 7, a first flow path 71, a second flow path 72, and a third flow path 73 are formed inside the nozzle 62. In the present embodiment, each of the first to third flow paths 71 to 73 has the same shape and size. In the present example, the shape of each of the first to third flow paths 71 to 73 is cylindrical.

FIG. 8 is an enlarged view of a region VIII shown in FIG. 3.

As shown in FIG. 8, in the connection posture, the base end of the first flow path 71 is communicated with the bottle storage chamber 52 through a fourth opening 84. The tip of the first flow path 71 is communicated with the outside of the nozzle 62 through a first opening 81. Similarly, the base end of the second flow path 72 is communicated with the bottle storage chamber 52 through a fifth opening 85. The tip of the second flow path 72 is communicated with the outside of the nozzle 62 through a second opening 82. Similarly, the base end of the third flow path 73 is communicated with the bottle storage chamber 52 through a sixth opening 86. The tip of the third flow path 73 is communicated with the outside of the nozzle 62 through a third opening 83.

That is, in the present embodiment, the bottle storage chamber 52 and the outside of the bottle main body 42 are communicated with each other only through the first flow path 71, the second flow path 72, and the third flow path 73.

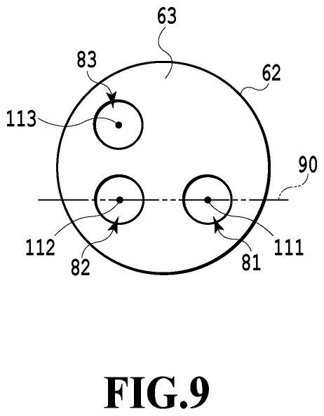

FIG. 9 is a schematic plan view of the edge face 63 according to the present embodiment.

As shown in FIG. 9, in the present embodiment, in a case where the edge face 63 is viewed from the perpendicular direction, the shape of the edge face 63 is circular. With respect to a virtual line 90 connecting the centroids of two of the three formed openings, the centroid of the remaining opening is not located on the virtual line 90. Here, for convenience of description, the centroid (in the case of a perfect circle, the center) of the first opening 81 will be referred to as a centroid 111, the centroid of the second opening 82 will be referred to as a centroid 112, and the centroid of the third opening 83 will be referred to as a centroid 113 to give a description.

In the present example, in a case where the edge face 63 is viewed from the perpendicular direction, the centroid 113 of the third opening 83 is not located on the virtual line 90 connecting the centroid 111 of the first opening 81 and the centroid 112 of the second opening 82. Further, in a case where the edge face 63 is viewed from the perpendicular direction, not only the centroid 111 but also the entire third opening 83 is not located on the virtual line 90 connecting the centroid 111 of the first opening 81 and the centroid 112 of the second opening 82. In the present embodiment, the opening areas of the first opening 81, the second opening 82, and the third opening 83 are the same.

### [Liquid Injection Operation]

Hereinafter, referring to FIGS. 3 and 8 again, a description will be given of a liquid supply from the bottle 41 in the connection posture to the liquid tank 22.

As shown in FIGS. 3 and 8, in a case where the bottle 41 is connected to the liquid tank 22 by the nozzle 62 being inserted into the insertion slot portion 33, the first opening 81, the second opening 82, and the third opening 83 are located within the tank storage chamber 32 of the liquid tank 22. As a result, the bottle storage chamber 52 of the bottle 41 and the tank storage chamber 32 of the liquid tank 22 are communicated with each other through the first flow path 71, the second flow path 72, and the third flow path 73, and liquid is injected into the tank storage chamber 32 from at least a portion of the flow paths.

As liquid accommodated in the tank storage chamber 32 decreases in amount, air flows into the tank storage chamber 32 through the air communication port 24. In a case where the liquid in the tank storage chamber 32 is consumed and new liquid is injected from the bottle 41, the air present in the tank storage chamber 32 flows into the bottle storage chamber 52 via the second flow path 72.

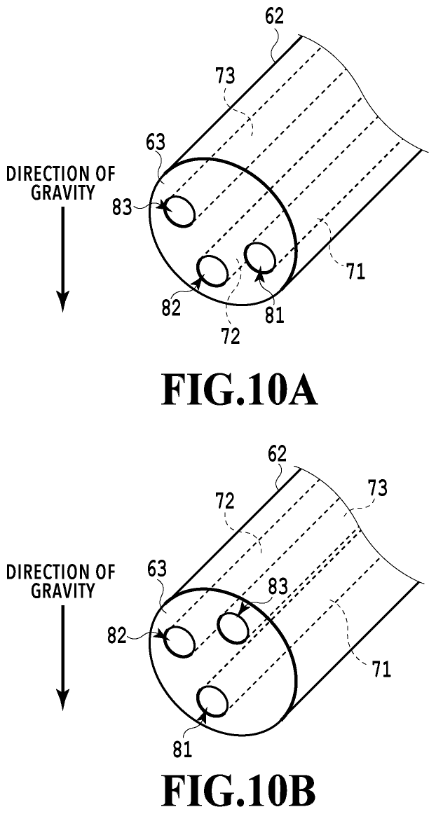

FIGS. 10A and 10B are perspective views showing an example of connection postures. FIG. 10A is a diagram showing an example of connection postures in which two openings are located downward in the direction of gravity. FIG. 10B is a diagram showing an example of connection postures different from that in FIG. 10A.

First, the case of FIG. 10A will be described. In the connection posture shown in FIG. 10A, the first opening 81 and the second opening 82 are arranged relatively downward with respect to the direction of gravity. On the other hand, the third opening 83 is arranged relatively upward with respect to the direction of gravity.

In this case, liquid stored in the bottle storage chamber 52 (see FIGS. 3 and 8) flows through the fourth opening 84 and the fifth opening 85 into the first flow path 71 and the second flow path 72, respectively, in relation to a water head difference. The liquid then flows into the tank storage chamber 32 of the liquid tank 22 from the first opening 81 and the second opening 82 via the first flow path 71 and the second flow path 72, respectively.

On the other hand, at the time of liquid circulation, air in the tank storage chamber 32 flows into the third flow path 73 through the third opening 83. The air then flows into the bottle storage chamber 52 (see FIGS. 3 and 8) of the bottle 41 (see FIG. 4) through the sixth opening 86 via the third flow path 73. In the present embodiment, liquid can be injected from the bottle 41 into the liquid tank 22 while a gas-liquid exchange is being made as described above.

Next, a description will be given of the case of a connection posture in which the bottle 41 (see FIGS. 3 and 8) is rotated about 90 degrees clockwise from the state shown in FIG. 10A. In the connection posture in FIG. 10B, the second opening 82 and the third opening 83 are arranged relatively upward with respect to the direction of gravity. On the other hand, the first opening 81 is arranged relatively downward with respect to the direction of gravity.

In this case, liquid stored in the bottle storage chamber 52 (see FIGS. 3 and 8) flows into the first flow path 71 through the fourth opening 84 (see FIG. 8) in relation to a water head difference. The liquid then flows into the tank storage chamber 32 of the liquid tank 22 from the first opening 81 via the first flow path 71.

On the other hand, at the time of liquid circulation, air in the tank storage chamber 32 flows into the second flow path 72 and the third flow path 73 through the second opening 82 and the third opening 83, respectively. The air then flows into the bottle storage chamber 52 (see FIGS. 3 and 8) of the bottle 41 (see FIG. 4) through the fifth opening 85 and the sixth opening 86 via the second flow path 72 and the third flow path 73, respectively.

As described above, in the liquid container according to the present embodiment, even in the connection posture in which two openings are at the same height in the horizontal direction, the other opening is always arranged at a height different from those of the two openings. In the present embodiment, liquid can be injected from the bottle 41 into the liquid tank 22 while a gas-liquid exchange is being made as described above. All the liquid in the bottle storage chamber 52 of the bottle 41 (see FIGS. 3 and 8) flows into the tank storage chamber 32 of the liquid tank 22, and the gas-liquid exchange is then completed.

Incidentally, the three openings may be in height positions different from each other (high, middle, low), such as the rotational positions between FIGS. 10A and 10B. In this case, the lowest flow path functions as a liquid outflow path, and the highest flow path functions as an air inflow path. The flow path in the middle position is not necessarily used for either liquid outflow or air inflow. Depending on the positions of the openings and the amount of liquid in the bottle storage chamber 52 at the time of liquid injection, the function may shift from liquid outflow to air inflow during an injection operation. Both liquid outflow and air inflow may occur at the same time through a single flow path, of course. In any case, a smooth gas-liquid exchange can be made.

### [Conclusion]

As described above, in the liquid container according to the present embodiment, a clear water head difference is made among the three flow paths at any rotation angle in an injection posture and each flow path functions as a liquid outflow path or an air inflow path. Thus, a user can connect the liquid container to the liquid tank without being conscious of the positional relationship between an opening through which liquid flows out and an opening through which air flows in and can perform the liquid injection operation reliably and smoothly.

Thus, using the liquid container according to the present embodiment can increase usability as compared with the conventional art. Further, it is not necessary to provide the liquid container with a mark making a user conscious of the positional relationship between openings and it is possible to reduce costs for manufacturing the liquid container. Furthermore, since the numbers of openings and flow paths are greater than in the conventional art, it is possible to relatively reduce liquid injection time.

### Second Embodiment

A description will be given below of a second embodiment in the technique according to the present disclosure with reference to the drawings. In the following description, the same reference numeral and name are used for a constituent identical to or corresponding to that in the first embodiment, the description thereof is appropriately omitted, and differences are mainly described.

In the present embodiment, the three openings are arranged so that a shape formed by connecting the centroids of the three openings is a regular triangle. The object of the present embodiment is to easily make a water head difference at the time of a liquid injection operation.

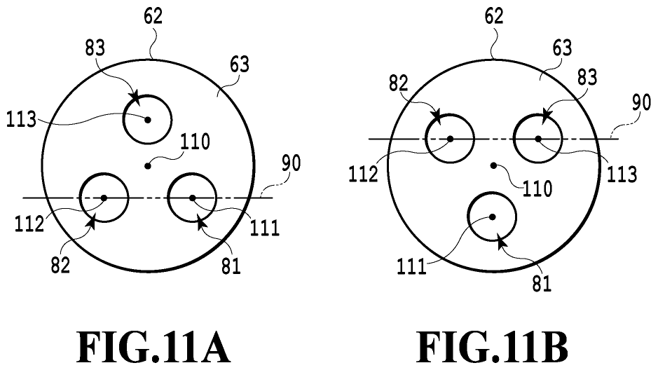

FIGS. 11A and 11B are diagrams showing an example of the nozzle 62 according to the present embodiment. FIG. 11A is a schematic plan view of the edge face 63 of the nozzle 62 according to the present embodiment. FIG. 11B is a diagram showing the edge face 63 in a state where the bottle 41 according to the present embodiment is rotated about 60 degrees clockwise from the state shown in FIG. 11A.

As shown in FIG. 11A, in the present embodiment, distances between the centroids of the first opening 81, the second opening 82, and the third opening 83 are equal to each other. In the present embodiment, the greater a distance from the centroid 111 to the centroid 112, a distance from the centroid 112 to the centroid 113, and a distance from the centroid 113 to the centroid 111 are, the greater a water head difference can be made among the three flow paths.

Further, distances from the centroid 110 of the edge face 63 of the nozzle 62 to the centroids 111, 112, and 113 are equal to each other. Furthermore, in the present embodiment, the position of the centroid of a shape (in the present example, a regular triangle) formed by connecting the centroids 111, 112, and 113 coincides with the position of the centroid 110.

As shown in FIG. 11A, with respect to the virtual line 90 connecting the centroids of two of the three openings, the centroid of the remaining opening is not located on the virtual line 90. As shown in FIG. 11B, even in a case where the bottle 41 is rotated about 60 degrees clockwise from the state shown in FIG. 11A, with respect to the virtual line 90 connecting the centroids of two of the above three openings, the centroid of the remaining opening is not located on the virtual line 90.

In such an opening arrangement, it is possible to appropriately keep distances between the three openings from each other. As a result, it is easy to make a water head difference at the time of the injection operation. Thus, using even such a liquid container according to the present embodiment can increase usability as compared with the conventional art.

### Third Embodiment

A description will be given below of a third embodiment in the technique according to the present disclosure with reference to the drawings. In the following description, the same reference numeral and name are used for a constituent identical to or corresponding to that in the first embodiment or the second embodiment, the description thereof is appropriately omitted, and differences are mainly described. The present embodiment is different from the first or second embodiment in that four openings are arranged in the present embodiment. The object of the present embodiment is to reduce liquid injection time.

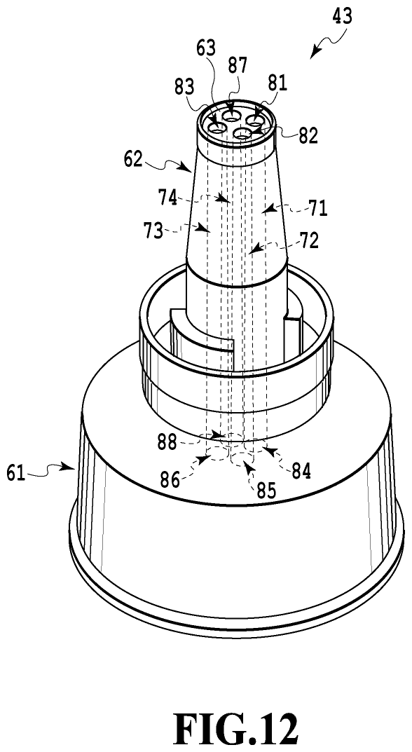

FIG. 12 is a schematic diagram of the bottle cap 43 according to the present embodiment.

As shown in FIG. 12, a fourth flow path 74 is formed inside the nozzle 62 formed in the bottle cap 43 according to the present embodiment. A seventh opening 87 in the fourth flow path 74 is formed on the edge face 63 constituting the leading edge of the nozzle 62 in the projecting direction. An eighth opening 88 in the fourth flow path 74 is formed on the base end side of the nozzle 62 in the projecting direction.

In the present embodiment, the first opening 81, the second opening 82, the third opening 83, and the seventh opening 87 are formed on the edge face 63. That is, in the present embodiment, the first opening 81, the second opening 82, the third opening 83, and the seventh opening 87 are located on the same plane.

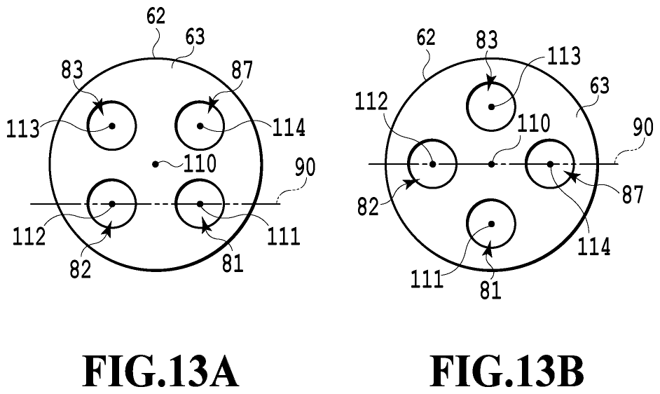

FIGS. 13A and 13B are schematic plan views of the edge face 63 according to the present embodiment. FIG. 13B is a diagram showing a state where the bottle 41 according to the present embodiment is rotated about 45 degrees clockwise from the state shown in FIG. 13A.

As shown in FIG. 13A, in the present embodiment, with respect to the virtual line 90 connecting the centroids of two of the four openings formed on the edge face 63, the centroids of the remaining two openings are not located on the virtual line 90.

In a case where the edge face 63 is viewed from the perpendicular direction, the third opening 83 and the seventh opening 87 are not located on the virtual line 90 connecting the centroid 111 of the first opening 81 and the centroid 112 of the second opening 82. Further, distances from the centroid 110 of the edge face 63 to the centroid 111 of the first opening 81, the centroid 112 of the second opening 82, the centroid 113 of the third opening 83, and the centroid 114 of the seventh opening 87 are all equal. Furthermore, in the present embodiment, the position of the centroid of a shape (in the present example, a square) formed by connecting the centroids 111, 112, 113, and 114 coincides with the position of the centroid 110.

As shown in FIG. 13B, even in a case where the bottle 41 is rotated about 45 degrees clockwise from the state shown in FIG. 13A, with respect to the virtual line 90 connecting the centroids of two of the above four openings, none of the remaining two openings and the centroids thereof is located on the virtual line 90. In the present example, neither the centroid 111 nor the centroid 113 is located on the virtual line 90 connecting the centroid 112 and the centroid 114.

In such an opening arrangement, even in a case where four or more openings are formed on the edge face 63 of the nozzle 62, not all of the openings are aligned in the horizontal direction. Accordingly, these openings can always maintain a positional relationship in the up-and-down direction with respect to the direction of gravity during the injection operation. Thus, even in a case where a user connects the liquid container to the liquid tank without being conscious of the positional relationship among a plurality of openings formed on the edge face 63, it is easy to make a water head difference and a gas-liquid exchange.

Thus, using even such a liquid container according to the present embodiment can increase usability as compared with the conventional art. Further, in a case where two openings are located upward in the direction of gravity, more air can flow in than in the examples shown in FIGS. 10A and 10B and a gas-liquid exchange can be made more smoothly. As a result, liquid injection time can be reduced.

### OTHER EMBODIMENTS

In the above embodiments, the shape of each opening formed on the edge face 63 is circular. However, the same advantageous result as that according to the above embodiments can be obtained even in a case where the shape of the opening is not circular.

Additionally, the above-described first embodiment, second embodiment, and third embodiment may be modified as appropriate. For example, in FIGS. 11A and 11B, the shape formed by connecting the centroids of the three openings is a regular triangle but may be an isosceles triangle. In FIGS. 13A and 13B, the shape formed by connecting the centroids of the four openings is a square but may be a rectangle.

In the example in FIG. 7, each of the first to third flow paths 71 to 73 has a cylindrical shape. However, the flow paths may have a shape other than a cylindrical shape. The cross-sectional shapes or cross-sectional areas of the three flow paths may be different from each other.

According to the present disclosure, it is possible to provide a liquid container having increased usability over the conventional art.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-164270, filed Oct. 12, 2022 which is hereby incorporated by reference wherein in its entirety.

What is claimed is:

1. A liquid container comprising:
a main body including a storage chamber storing liquid; and
a nozzle projecting from the main body,
wherein in the nozzle, a first flow path, a second flow path, and a third flow path are formed,
the first flow path brings the storage chamber into communication with an outside through a first opening formed on an edge face constituting a leading edge of the nozzle,
the second flow path brings the storage chamber into communication with the outside through a second opening formed on the edge face,
the third flow path brings the storage chamber into communication with the outside through a third opening formed on the edge face, and
in a case where the edge face is viewed from a perpendicular direction of the edge face, a centroid of the third opening is not located on a line connecting a centroid of the first opening and a centroid of the second opening.

2. The liquid container according to claim 1, wherein
in a case where the edge face is viewed from the perpendicular direction of the edge face, the third opening is not located on the line connecting the centroid of the first opening and the centroid of the second opening.

3. The liquid container according to claim 1, wherein
a distance from the centroid of the first opening to the centroid of the second opening, a distance from the centroid of the second opening to the centroid of the third opening, and a distance from the centroid of the third opening to the centroid of the first opening are equal to each other.

4. The liquid container according to claim 1, wherein
the centroid of the first opening, the centroid of the second opening, and the centroid of the third opening are at an equal distance from a centroid of the edge face.

5. The liquid container according to claim 1, wherein
a position of a centroid of a triangle formed by connecting the centroid of the first opening, the centroid of the second opening, and the centroid of the third opening coincides with a position of a centroid of the edge face.

6. The liquid container according to claim 1, wherein
the first opening, the second opening, and the third opening are circular.

7. The liquid container according to claim 1, wherein
the main body has a cylindrical shape, and the edge face is circular.

8. The liquid container according to claim 1, wherein
in the nozzle, a fourth flow path is further formed,
the fourth flow path brings the storage chamber into communication with the outside through a fourth opening formed on the edge face, and
in a case where the edge face is viewed from the perpendicular direction of the edge face, a centroid of the fourth opening is not located on the line connecting the centroid of the first opening and the centroid of the second opening.

9. The liquid container according to claim 8, wherein
in a case where the edge face is viewed from the perpendicular direction of the edge face, the fourth opening is not located on the line connecting the centroid of the first opening and the centroid of the second opening.

10. The liquid container according to claim 8, wherein
a distance from the centroid of the first opening to the centroid of the second opening, a distance from the centroid of the second opening to the centroid of the third opening, a distance from the centroid of the third opening to the centroid of the fourth opening, and a distance from the centroid of the fourth opening to the centroid of the first opening are equal to each other.

11. The liquid container according to claim 8, wherein
the centroid of the first opening, the centroid of the second opening, the centroid of the third opening, and the centroid of the fourth opening are at an equal distance from a centroid of the edge face.

12. The liquid container according to claim 8, wherein
the fourth opening is circular.

13. The liquid container according to claim 8, wherein
a position of a centroid of a rectangle formed by connecting the centroid of the first opening, the centroid of the second opening, the centroid of the third opening, and the centroid of the fourth opening coincides with a position of a centroid of the edge face.

14. A printing apparatus comprising:
a print head configured to eject liquid to perform printing;
a liquid tank connectable to a liquid container; and
a tube capable of supplying liquid from the liquid tank to the print head, wherein the liquid container comprises the liquid tank connectable via a nozzle to a liquid container comprising a main body including a storage chamber storing liquid and the nozzle projecting from the main body, wherein in the nozzle, a first flow path, a second flow path, and a third flow path are formed, the first flow path brings the storage chamber into communication with an outside through a first opening formed on an edge face constituting a leading edge of the nozzle, the second flow path brings the storage chamber into communication with the outside through a second opening formed on the edge face, the third flow path brings the storage chamber into communication with the outside through a third opening formed on the edge face, and in a case where the edge face is viewed from a perpendicular direction of the edge face, a centroid of the third opening is not located on a line connecting a centroid of the first opening and a centroid of the second opening, the liquid tank being capable of storing liquid injected from the liquid container.

15. The printing apparatus according to claim 14, wherein
the liquid tank includes an inclined wall inclined with respect to a planer direction and a perpendicular direction, and
an insertion slot portion into which the nozzle can be inserted is formed on the inclined wall.

16. The printing apparatus according to claim 14, wherein
the liquid tank comprises an air communication port through which an inside of the liquid tank is communicated with air.
